(19) United States
(12) Patent Application Publication
(10) Pub. No.: US 2024/0139737 A1
(43) Pub. Date: May 2, 2024

(54) CARTRIDGE AND METHOD FOR CARRYING OUT A REACTION

(71) Applicant: Universitaet zu Koeln, Koeln (DE)

(72) Inventors: Bernhard SCHERMER, Bruehl (DE); Roman Ulrich MUELLER, Koeln (DE); Francesca FABRETTI, Koeln (DE); Thomas BENZING, Koeln (DE); Sebastian BARGFREDE, Koeln (DE); Reza ESMAILLIE, Koeln (DE); Boris CHRISTOFFEL, Koeln (DE); Oliver Bernd FEIERABEND, Huerth (DE); Robin BAYER, Juelich (DE)

(21) Appl. No.: 18/550,580

(22) PCT Filed: Mar. 11, 2022
(86) PCT No.: PCT/EP2022/056395

§ 371 Date: Oct. 10, 2023

(30) Foreign Application Priority Data
Mar. 18, 2021 (DE) 10 2021 106 654.9

(51) Int. Cl. B01L 3/00

(52) U.S. Cl. CPC B01L 3/502723; B01L 3/502738; B01L 2200/0684; B01L 2200/16; B01L 2300/0816; B01L 2300/0867; B01L 2400/0481; B01L 2400/0622

(57) ABSTRACT

In a method and a cartridge for carrying out a reaction between a sample fluid and at least one reagent, in particular for carrying out LAMP assays, the cartridge includes at least one channel pair including a sample channel into which a sample fluid can be introduced and a reagent channel into which a reagent fluid can be introduced, the sample channel and the reagent channel being disposed so as to intersect one another whereby sample fluid can be transferred from an intersecting region into the reagent channel.

The invention relates to a cartridge and to a method for carrying out a reaction between a sample fluid and at least one reagent. The invention furthermore relates to a cartridge body and a carrier element therefor.

Such a cartridge and the method can be employed, for example, for carrying out LAMP assays, for example so as to determine a viral load, or other microbes, in a liquid sample fluid, or to detect DNA-based/RNA-based biomarkers. The abbreviation LAMP denotes loop-mediated isothermal amplification and refers to a method for copying DNA. For RNA, rtLAMP is used in the cartridge. Amplification is preceded by a reverse transcription of viral RNA into DNA. The method can be carried out more easily than polymerase chain reactions and, against the background of the current Covid-19 pandemic, is gaining increasing importance. The method is suited for detecting the presence of a certain viral DNA or viral RNA, for example of the so-called Coronavirus and of the mutations thereof, for example based on a change in color or changed fluorescence taking place during the reaction.

Even though the invention is preferably used with LAMP assays, it is not limited thereto. Generally, it is possible to perform any reactions between a preferably liquid sample fluid and a preferably liquid reagent fluid by way of the invention.

Other assays would be, for example, recombinase polymerase amplification (RPA), helicase-dependent amplification (HDA), transcription-mediated amplification (TMA), rolling circle replication (RCR), pulse-controlled amplification (PCA), polymerase chain reaction (PCR), and enzyme-linked immunosorbent assay (ELISA).

The cartridge and the method are used to bring a, preferably liquid, sample fluid, in which, for example, viral DNA/RNA may be present, and a, preferably liquid, reagent fluid in contact with one another in the cartridge so as to have a reaction take place between the components of the fluids upon contact, for example in the case of a LAMP assay, the copying of DNA. It may be provided that the outcome of a reaction can be evaluated directly in the cartridge, for example being read out, or being detected photographically or videographically or by way of fluorescence and being evaluated using software. As mentioned above, a reaction can, for example, cause an observable change in color or turbidity, or an increase in a fluorescence signal.

Within the meaning of the invention, a cartridge shall preferably be understood to mean an assembly, for example a three-dimensional body or housing, in which spatial areas, for example channels and chambers, are integrated for the purpose of guiding fluid and carrying out a reaction. A cartridge of this type allows the option of carrying out the particular reaction between the samples and the reagents even if laboratory conditions are not present.

A cartridge and a method for carrying out a reaction between a sample fluid and at least one reagent is known, for example, from the publication Ganguli A et al.: Rapid isothermal amplification and portable detection system for SARS-CoV-2. PNAS: Sep. 15, 2020, vol. 117, no. 37, 22727-22735.

The cartridge produced by 3D printing shown there includes a sample channel and a reagent channel, each having an inlet port, to which a syringe can be attached so as to fill the relevant channel with sample fluid or reagent fluid. In this shown cartridge, the two channels merge to form a single mixing channel in which, downstream from the merging location, the two fluids are guided together and mixed in a mixing zone extending in a meander-shaped manner, and which, downstream from the mixing zone, opens into a reaction chamber in which the reaction can take place and be detected; here, for example, metrologically by way of a camera.

The problem with the known cartridge is that the volume fraction of the sample fluid in relation to the reagent fluid cannot be determined with sufficient precision. Rather, the amount of sample fluid and the amount of reagent that are injected by the user in the particular channel, using respective syringes, with the reagent fluid, depend on the skill of the user. Frequently, only very small volumes of sample fluid are required for reactions, for example in the range of only a few microliters. In contrast, it is only with difficulty that it is possible to reproducibly implement limitations to such small volumes by injection using a syringe. As a result, there is a risk that too much sample fluid is used, whereupon the copying reaction cannot take place sufficiently reliably, or that too little sample fluid is injected if the task is approached too cautiously.

It is therefore an object of the invention to provide a cartridge and a method, by way of which the volume of the sample liquid required for a particular reaction with the reagent can be determined more precisely, and in particular by way of which it is ensured that a sufficient but not excessive amount of sample liquid makes contact with the reagent. It is furthermore an object to also be able to better adjust the amount of reagent in the reaction chamber of a cartridge. Another object is to create a cartridge that is at least partially reusable. It is also an object to simplify the production of the cartridge.

This object is achieved by a cartridge comprising at least one channel pair, which includes a sample channel into which a sample fluid can be introduced and a reagent channel into which a reagent fluid can be introduced, the sample channel and the reagent channel being disposed so as to intersect one another.

To intersect shall be understood to mean that the sample channel and the reagent channel pass through one another in the intersecting region, which is to say have a shared volume region there. Each of the two channels extends beyond the intersecting region. For the sample channel and/or on the reagent channel, the channel sections on both sides of the intersecting region are preferably aligned. In particular, the two channel sections on both sides of the intersecting region have the same center axis and the same cross-section.

It may furthermore be provided that the cross-sections of the sample channel and the reagent channel are identical, at least in the channel sections opening into the intersecting region. However, this is not mandatory, and these may also be different.

According to the invention, such an intersecting configuration of the channels allows the sample fluid to be transferred only from the intersecting region into the reagent channel, namely into the portion of the reagent channel that is located downstream from the intersecting region when this portion is being filled.

In contrast to the aforementioned prior art, there is, accordingly, no mixing channel, in which arbitrary, and in particular indeterminate, amounts of fluid from the two channels can merge. In the invention, in contrast, the volume of the sample fluid participating in the reaction results only from a region originating around the intersecting center of the two channels. In the invention, the volume is thus limited and deterministically predetermined.

The method according to the invention provides for the sample channel to be filled with a sample fluid beyond the intersecting region at which the sample channel is intersected by the reagent channel. This ensures that the intersecting region is completely filled by the sample fluid. It is immaterial for the invention how much sample fluid overall is added to the sample channel since the sample fluid flows, beyond the intersecting region, into the region of the sample channel located downstream from the intersecting region and remains there, or exits the sample channel again into the surrounding area or a collection receptacle.

It is preferably provided that the sample channel of the cartridge is filled through an inlet port of the sample channel at the cartridge, while the sample channel is being vented at the outlet port thereof at the cartridge. In this way, pressure is prevented from building up in the sample channel while the same is being filled.

The sample channel advantageously extends between the inlet port thereof located at the cartridge and the outlet port thereof located at the cartridge, the intersecting region being located between these ports.

More preferably, the sample channel is being filled, while the reagent channel is sealed with respect to the surrounding area. In this way, it is ensured that no, or almost no, sample fluid enters the reagent channel at the intersecting region, since fluid would have to be displaced from the reagent channel, or at least the present air would have to be displaced by the sample fluid, which is not possible when sealing is provided with respect to the surrounding area.

The reagent channel is then filled with a reagent fluid beyond the intersecting region at which the reagent channel is intersected by the sample channel, into the channel section of the reagent channel located downstream from the intersecting region, preferably into a reaction chamber into which the reagent channel opens, wherein the sample fluid present in the intersecting region, which was previously added, is transferred out of the intersecting region into the channel section of the reagent channel located downstream from the intersecting region, preferably into a reaction chamber.

It may preferably be provided that the reagent channel is filled through an inlet port of the reagent channel while the reagent channel is being vented at the outlet port. In this way, pressure is prevented from building up in the reagent channel while the same is being filled.

The reagent channel advantageously extends between the inlet port thereof located at the cartridge and the outlet port thereof located at the cartridge, the intersecting region being located between these ports.

More preferably, the reagent channel is filled, while the sample channel is sealed with respect to the surrounding area. Filling and venting means, which were possibly previously connected to the ports of the sample channel, can, for example, be removed again for this purpose. As an alternative, the ports of the sample channel are connected in a different manner. In this way, it is ensured that no, or almost no, sample fluid present in the intersecting region can be pushed back into the sample channel, since the sample fluid would have to be displaced from the sample channel, which has already been filled at least regionally, which is not possible when sealing is provided with respect to the surrounding area.

The existing filling of the sample channel thus causes the sample fluid, which is present at the intersecting region, to be pushed only into the preferably vented channel section of the reagent channel which is located downstream from the intersecting region, when the reagent channel is being filled. It may be provided that the sample fluid is displaced from the intersecting region through the air cushion, which is situated upstream from the intersecting region in the reagent channel and pushes the reagent fluid along during filling.

In addition, the option exists for the reagent channel to be filled with reagent fluid prior to the sample channel being filled. The aforementioned method steps can then be carried out in the same manner.

Generally speaking, a port preferably denotes an interface in the cartridge which allows fluid, for example liquid or gas/air, to be added or discharged. An inlet port is provided for adding/injecting liquid into the relevant channel, and an outlet port is provided for venting or for discharging liquid from the relevant channel. Ports may, for example, comprise a mechanical connecting interface for a filling means/application means, such as a syringe. A port can, for example, comprise a so-called Luer lock. Likewise, a port can comprise a piercable membrane, for example to be pierced by way of a cannula. Such a membrane advantageously closes when the cannula is pulled out.

A port can furthermore be a region having an increased cross-section compared to the other channel regions. A port can furthermore preferably be, for example, originally open and be closable by connecting, for example, a syringe, or vice versa, and can preferably be originally closed and openable by piercing with a cannula. A port can also comprise a valve so as to be able to selectively open or close the port. In particular, an outlet port of the sample channel and/or reagent channel can also comprise a filter so as to avoid the surrounding area being contaminated by any leaking fluid.

Each of the two channels preferably has a dedicated pair of inlet port and outlet port. It may also be provided that the two channels have a shared outlet port, in particular when only venting during channel filling is provided for by the outlet port.

One possible embodiment can also provide that the sample channel, and in particular the inlet port thereof, is connected to a sample receiving chamber, in particular for a sample carrier. In such a case, the, preferably liquid, sample fluid, which includes the sample to be examined, is not transferred from outside the cartridge into the same, but is produced therein, namely in the sample receiving chamber situated within the cartridge.

For this purpose, the sample is transferred directly, or adhering to a sample carrier, into the sample receiving chamber and brought in contact there with a carrier liquid, into which the sample transfers and thereby forms the liquid sample fluid.

The inlet port of the sample channel can be a region of the sample receiving chamber into which the sample fluid can be transferred from the sample receiving chamber, for example by tilting of the cartridge.

A connection can be provided on the sample receiving chamber so as to apply pressure thereto and thereby push the sample fluid out of the sample receiving chamber, via the inlet port, into the sample channel, and beyond the intersecting region, preferably while venting is being provided at the outlet port of the sample channel.

The invention generally precludes an excessive amount of sample fluid being used during the reaction. Incorrect filling due to overfilling is effectively prevented.

Compared to the aforementioned prior art, the invention preferably makes it possible for the volume of sample fluid transferred to be limited, and preferably defined, to a known level, namely limited to, or defined as, the volume of the sample fluid which is situated in the intersecting region of the two channels, since only this volume will be moved out of the intersecting region during the subsequent filling of the reagent channel with reagent fluid, and thus the reaction will be based only on this volume.

Particularly preferably, it is provided that the intersecting region limits the transfer volume to, or defines the transfer volume as, the volume that is present simultaneously in the sample channel and the reagent channel, multiplied by a factor U, wherein the factor is between 0.75 and 1.25, preferably between 0.8 and 1.2, more preferably between 0.9 and 1.1, still more preferably between 0.95 and 1.05, still more preferably between 0.99 and 1.01, with U=1 being particularly preferred.

If no further volume-defining elements are provided in the intersecting region, the exact intersecting volume may be understood to mean the volume of the intersecting body of two cylinders that penetrate one another and have the cross-sections of the two intersecting channels. Due to fluidic effects, and possibly displacement effects in the intersecting region, which cannot be entirely precluded, the transfer volume may be greater or smaller than the exact intersecting volume. This is taken into consideration by the factor U. The invention can preferably provide that the actual transfer volume deviates by no more than 25% from the exact intersecting volume. The factor U can be empirically ascertained, for example, and, for a particular channel configuration in the intersection region, is a fixed value for all cartridges having this particular configuration.

As a result of the invention, it is thus not only achieved that overfilling is precluded, but it is also possible to provide defined volume information for the transfer volume of the sample fluid, which results from the exact geometric intersecting volume.

For example, it may be provided in the above-described or following embodiment that the transfer volume, which is transferred from the sample fluid from the sample channel into the reagent channel downstream from the intersecting region, is 0.5 to 3 microliters, and preferably 1 to 2 microliters.

Another possible embodiment of the invention can also provide that an element defining the transfer volume is utilized in the intersecting region.

This is preferably a valve, and in particular a 4-way valve. Such a valve comprises, for example, a valve element having a through-channel which, in one position, can be set so as to be aligned with the sample channel and, in another position, can be set so as to be aligned with the reagent channel. The through-channel can thus connect the channel section of one of the two channels which is located upstream from the intersecting region to the channel section of the same channel which is located downstream from the intersecting region. At the site of the intersecting region, it is thus possible, by way of the valve, to switch either the sample channel so as to be continuous beyond the intersecting region, while the reagent channel at the intersecting region is blocked at the same time, or to switch the reagent channel so as to be continuous beyond the intersecting region, while the sample channel at the intersecting region is blocked at the same time.

The axis of rotation of the valve element is preferably situated in the intersecting region, and in particular extends through the intersecting center of the two channels.

In this embodiment, the transfer volume is thus defined by the volume in the valve element of the switching valve located in the intersecting region, and in particular as the volume of a through-channel in the valve element thereof, by way of which, alternatively, the sample channel or the reagent channel can be switched so as to be continuous at the location of the intersecting region.

The embodiment comprising a valve in the intersecting region has the advantage that the filling of one of the two channels has no effect whatsoever on the other of the two channels, since these are decoupled from one another by the valve.

When using a valve in the cartridge at the location of the intersection, the method according to the invention can thus provide that the through-channel in the valve element for the sample channel is set so as to be continuous when the sample channel is being filled, and that the switching valve disposed at the location of the intersection, prior to the reagent channel being filled, is switched from the through-position of the valve element for the sample channel into a through-position of the valve element for the reagent channel, whereby the sample fluid present in the valve element, or in the through-channel thereof, is transferred from the sample channel into the reagent channel.

Regardless of the specific design of the cartridge at the intersecting region, which is to say, in particular, whether a volume-defining element (valve) is present or not, the invention can preferably provide that the reagent channel, spaced apart from the intersecting region, and in particular downstream therefrom, comprises a reaction chamber, in particular having a cross-section that is greater than the cross-section of the reagent channel opening into the reaction chamber. The transferred sample fluid and the reagents or the reagent fluid can be present in a mixed state and react in this reaction chamber. The mixing can be carried out in the reaction chamber and/or between the intersecting region and the reaction chamber, for example in a mixing zone of the reagent channel, which in particular has a meander-shaped design or comprises elements that support the mixing process.

The invention can also provide an embodiment comprising a second valve, which is provided in addition to the volume-defining valve. Such a second valve is disposed downstream from the reaction chamber. This chamber is then disposed between the two valves and, by way of the two valves, can be completely separated from the reagent channel, for which purpose the two valves can be moved into a position in which these block the reagent channel. The two valves can be mechanically coupled to one another so that one of the valves being moved causes the other to be moved.

In one possible embodiment, the invention can provide that the reagent fluid, which is injected through the inlet port of the reagent channel into the reagent channel, already comprises the reagents necessary for the reaction, in particular in dissolved form.

However, another option can also provide that a reagent, preferably a lyophilized reagent, is stored in the reaction channel, preferably in the reaction chamber thereof or in a region upstream from the reaction chamber, preferably between the intersecting region and the reaction chamber.

It is provided in such a case that the reagent fluid injected via the inlet port does not itself include any reagents for the reaction, but simple water or a solvent. In the invention, the term ‘reagent fluid’ thus does not necessarily imply the presence of reagents in the fluid at the point in time at which this is injected into the cartridge.

This embodiment comprising a reagent store in the cartridge has the advantage that the amount of reagents in the store can be exactly predetermined. Furthermore, stored reagent, in particular in lyophilized form, can be preserved or is reactive for a particularly long time.

Similarly to the prior art, the cartridge can be present in the form of a plastic body, having channels, and possibly chambers and ports, formed therein. Such a plastic body can, for example, be additively produced, for example by way of 3D printing, or by primary shaping, such as injection molding or blow molding.

According to a particularly preferred embodiment of the invention, the cartridge comprises a cartridge body, which is disposed on a carrier element, wherein the channels are surrounded by the cartridge body in some regions, and by the carrier element in some regions. The cartridge body and the carrier element together thus form the cartridge. The option therefore exists to design one of the elements, preferably the carrier element, so as to be reusable. Preferably, all spatial regions of the cartridge body that can be filled with fluid open into a planar connecting surface, via which the cartridge body is connected to a planar surface of the carrier element.

The carrier element can, for example, be designed as a plate, preferably a glass plate, which has a planar connecting surface, at which the cartridge body is connected to the likewise planar connecting surface so as to form the cartridge.

For example, it may be provided by the invention to use a microscope glass slide as the carrier element for the cartridge body.

The carrier element, and in particular the glass plate, can include a store of reagent, preferably a lyophilized reagent, at the site that, after being joined with a cartridge body, is located in the reagent channel of the cartridge, and preferably in the reaction chamber of the reagent channel. It is thus possible, for example, to industrially produce carrier elements including a reagent store, which, after being joined with the cartridge body, form the ready-to-use cartridge.

The cartridge body is particularly preferably made of an elastomeric, preferably flexible, material, and particularly preferably is made of silicone. The cartridge body is thus preferably formed by completely cured silicone.

It is furthermore preferred when the cartridge body and the carrier element are joined to one another adhesively, in particular without any interposed adhesive, and can be detached from one another without residue. This is possible without difficulty, for example, when using silicone for the cartridge body, and when using a glass plate for the carrier element, since the bonding strength of silicone to glass is high, even in the completely cured state. Likewise, the option exists to use an adhesive for joining the cartridge body and the carrier element.

The aforementioned embodiments allow the option of using a negative mold for producing a cartridge body, the shape of which in particular defines the progression and location of the channels and, in particular, also of the ports and/or of the reaction chamber. The base/bottom of the negative mold preferably forms a planar surface, from which ridges extend upwardly, which define at least the channels, and preferably also the ports.

By pouring a casting compound, for example silicone, into the negative mold, the cartridge body can be molded from the negative mold and, together with a carrier element, and in particular a glass plate, can form the cartridge.

In this embodiment, the ports are preferably configured so as to comprise membranes made of silicone to be pierced with cannulas. In this embodiment, preferably, no valve is used.

In the method according to the invention, it may additionally be provided that, when the sample channel is being filled with sample fluid, the reagent channel on both sides of the intersecting region and/or, when the reagent channel is being filled with the reagent fluid, the sample channel on both sides of the intersecting region, are pinched off by compression of the material of the cartridge body, preferably by way of a pressing element, which in particular comprises two spaced-apart ridges, the distance of which is greater than or equal to the channel width of the channel to be filled.

In particular when carrying out LAMP assays, the invention can provide that the cartridge and the sample fluid present therein are heated before being filled with reagent fluid, preferably to a temperature greater than 90 degrees Celsius, in particular for denaturing viral envelopes in the sample fluid. This is particularly advantageously possible when using silicone and glass as materials of the cartridge.

The invention can provide a heatable mount in which one or more cartridges can be inserted for heating.

The invention can furthermore be brought to the desired temperature by using incubators for the appropriate duration.

As mentioned at the outset, a cartridge according to the invention comprises at least one pair of channels, which form the sample channel and the reagent channel and intersect one another. A cartridge can likewise comprise a multitude or plurality of such pairs so that multiple LAMP assays or other reactions can be carried out simultaneously with the cartridge.

Embodiments will be described in greater detail hereafter.

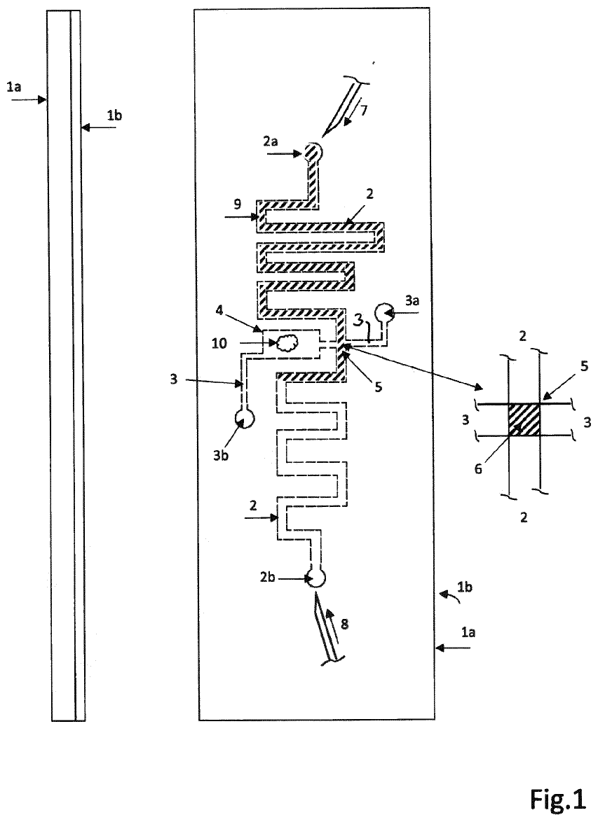

FIG. 1 shows a side illustration and a top view of a cartridge 1 comprising a cartridge body 1a, which is preferably made entirely of silicone, for example cast, and a carrier element 1b, to which the cartridge body 1a is attached, preferably in a detachably adhering manner without interposed adhesive.

In the top view, the arrangement of the channels 2, 3 can be seen. The channels 2, 3 here are essentially formed by grooves in the silicone body which, with all the fluid-guiding regions thereof, are open, and open into the surface area of the connecting plane 1c, in which the cartridge body 1a and the carrier element 1b are connected by the planar connecting surfaces thereof. The fluid-guiding regions here also include the ports 2a, 2b, 3a, 3b of the channels and the reaction chamber 4. The open grooves in the cartridge body 1a forming the channels, forming the ports and forming the reaction chamber are only closed by the carrier element 1b, and thereby form the channels 2, 3, the ports 2a, 2b, 3a, 3b thereof and the reaction chamber 4.

The sample channel 2 extends from the inlet port 2a thereof to an outlet port 2b. In the embodiment shown, the sample channel 2 extends in a meander-shaped manner, but this is not absolutely necessary. Generally, the sample channel 2 can have any progression and, for example, can also be also rectilinear.

The reagent channel 3 extends between the inlet port 3a thereof and the outlet port 3b thereof. The sample channel 2 and the reagent channel 3 intersect in the intersecting region 5, which is additionally shown in an enlarged form in FIG. 1. It is apparent here that the intersecting region 5 encompasses a hatched volume 6, which is part of the two channels 2, 3.

Downstream from the intersecting region, the reagent channel 3 expands from the inlet port 3a in the direction of the outlet port 3b to form a reaction chamber 4.

Within the cartridge body, the two channels are sealed with respect to the surrounding area, since these are surrounded by the material of the cartridge body 1a or the carrier element 1b.

A cannula 7 can be inserted into the inlet port 2a for filling the sample channel 2. Likewise, a cannula 8 for venting the sample channel 2 is inserted into the outlet port 2a. It is then possible to add a liquid sample fluid 9 via the cannula 7 into the sample channel 2, and more particularly at least so much that the sample fluid 9, which is shown here as a hatched area in the sample channel 2, beyond the intersecting region 5, enters the channel section of the sample channel 2 located downstream from the intersecting region 5. The sample fluid 9 does not have to reach the outlet port, but may also exit there.

Since the reagent channel 3 is sealed with respect to the surrounding area at this point in time, the air or other medium, possibly a liquid prefilled item, cannot be displaced by the sample fluid. The sample fluid thus only flows in a rectilinear manner in the direction of extension of the sample channel 2 across the intersecting region, without entering the reagent channel 3. The sample fluid 9 thus fills the volume 6 of the intersecting region 5.

After filling, the cannulas 7, 8 can be removed from the ports 2a, 2b of the sample channel 2 so as to seal the same again with respect to the surrounding area.

If the sample fluid comprises a virus sample, for example, which is to be detected by way of a LAMP assay, initially the sample fluid 9 can be heated, together with the entire cartridge 1, to over 90 degrees Celsius so as to denature the virus and release the DNA. After cooling, which may be supported, for example by way of Peltier element-based cooling, further filling is carried out. These steps of heating and cooling may also be dispensed with in the case of other reactions.

For filling the reagent channel 3, the inlet port 3a and the outlet port 3b of the reagent channel 3 are opened by way of cannulas, which are not shown, and a liquid reagent fluid is added to the reagent channel 3 via the inlet port 3a. The reagent fluid itself, or a fluid cushion, for example air, present in front thereof, pushes the sample fluid 9 in the intersecting region 5 in the amount of the volume 6 out of the intersecting region, in the direction toward the downstream portion of the reagent channel 3, and into the reaction chamber 4, where the sample fluid can mix with the reagent fluid, and a predetermined reaction can take place. The reaction chamber 4 can comprise a window, for example formed by a silicone membrane, through which the reaction, for example a change in color, can be observed. The arrangement of the inlet and outlet in the reaction chamber 4 depends on the orientation of the cartridge after filling, and is preferably configured so that the reagent reaches the exit only after the reaction chamber 4 has been completely filled.

The reagent fluid can, for example, comprise the reagents necessary for the reaction in dissolved form. It may also be provided that a store 10 of reagents, for example in lyophilized form, which dissolves in the reagent fluid, is disposed in the reaction chamber 4 or another portion of the reagent channel upstream from the reaction chamber 4. The added reagent fluid itself in this case may not comprise any reagents and, for example, may consist of water or another solvent.

The advantage of the invention results from the fact that only, or essentially only, the fraction (transfer volume) of sample fluid 9 from the sample channel 3 which corresponds to the intersecting volume 6 is transferred into the reaction chamber 4 and used for the reaction, since only this fraction reaches the reaction chamber 4. The transfer volume is thus very precisely defined in the invention.

In general, for reactions, it is not necessary to have absolutely precise knowledge of the transfer volume in the cartridge according to the invention, regardless of the variant embodiment, since, for meaningful reactions, for example in the case of LAMP assays, it is sufficient that the transfer volume is in a predetermined interval. This is achieved by way of the invention, for example, when, as a result of the selection of the geometric dimensions of the channels 2, 3, the exact intersecting volume 6 is selected so as to represent the center of the required interval. This applies accordingly to all possible applications.

The transfer volume of the sample fluid 9 can possibly be determined by multiplying the intersection volume 6 by a factor U when fluidic effects cause slightly more or slightly less than the intersecting volume 6 to be transferred from the intersecting region 5 into the reaction chamber 4. This factor U can be empirically determined and is the same for all cartridges of the same design.

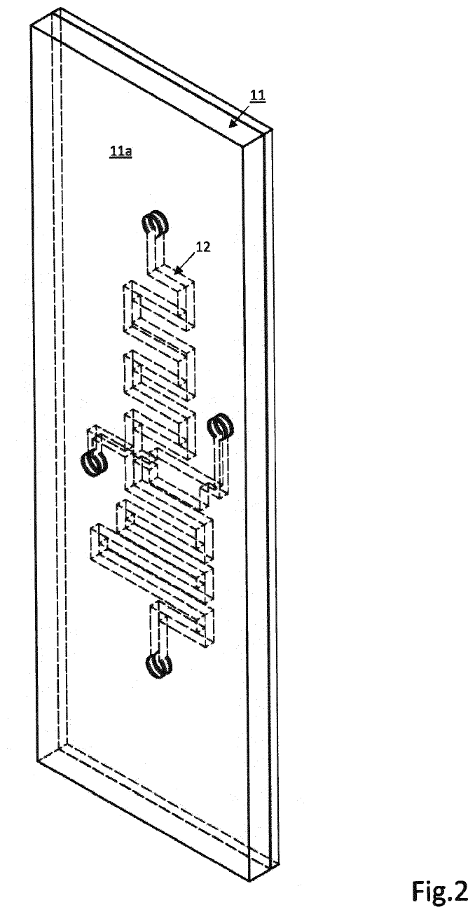

FIG. 2 shows a negative mold 11 in a perspective view. This represents a pan-shaped mold cavity, which can be filled with a casting compound, for example silicone, in the liquid state so as to obtain the cartridge body 1 according to FIG. 1 following the curing or the solidification of the casting compound.

The pan bottom 11a of the casting mold 11 is preferably planar. Ridges 12 project upwardly therefrom which, in the negative mold, form placeholders for the channels 2, 3, the ports 2a, 2b, 3a, 3b, and the reaction chamber 4 of the cartridge body 1 of FIG. 1.

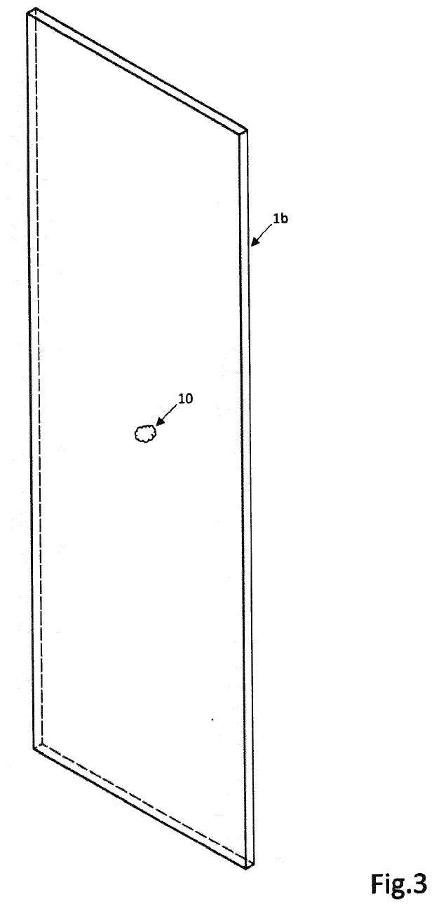

FIG. 3 shows a perspective view of a carrier element 1b of the cartridge 1 to be formed together with the cartridge body 1a. The carrier element 1b can, for example, be formed by a glass slide for microscopes, but may also be formed by any other glass plate or other plate. According to the invention, the carrier element 1b can be provided directly with a store 10 of preferably lyophilized reagents at a site that, after being joined with the cartridge body 1a, is located in the reagent channel 3 thereof, preferably in the reaction chamber thereof. This yields the advantage that it is only necessary to keep carrier elements 1b having different stored reagents available for different reactions, for example LAMP assays, which are always assembled with the same cartridge bodies 1a to form a cartridge 1.

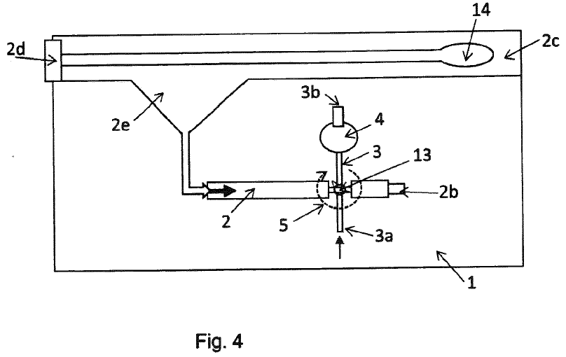

FIG. 4 shows a different embodiment of a cartridge comprising a sample channel 2, a reagent channel 3 and the ports 2a, 2b, 3a, 3b thereof. These again intersect one another at the intersecting region 5. In this embodiment, a switching valve 13 is disposed in this location, the valve element of which is switched so that, at the intersecting site, either the sample channel 2 or the reagent channel 3 is continuous, while the respective other channel is blocked.

Here, the transfer volume is exactly defined by the volume of the through-channel in the valve element. By rotation of the valve 13, sample fluid in this transfer volume is transferred from the sample channel into the reagent channel 3 and, when the same is being filled, is rinsed out of the valve element in the direction toward the reaction chamber 4.

FIG. 4 shows the addition of a sample receiving chamber 2c to the cartridge, which opens into the sample channel via the inlet port 2a. By way of a closure 2d, the sample receiving chamber 2c can be opened and, for example, a cotton swab 13 or other sample carrier can be inserted. As an alternative, saliva can be added directly to the sample chamber.

A fluid may already be present in the sample chamber or may be added thereto by way of the sample carrier. After the fluid has been mixed with the sample, this liquid forms the sample fluid, which can reach the sample channel 2 via the inlet port 2a. For this purpose, it may be provided to tilt the cartridge.

By way of suction at the outlet port 2b or pressure build-up in the sample chamber 2c or at the inlet port 2a, the sample fluid, as described above, is added to the sample channel beyond the intersecting region, where the fluid fills the valve element. The remaining steps are carried out after the valve 13 has been switched as described above.

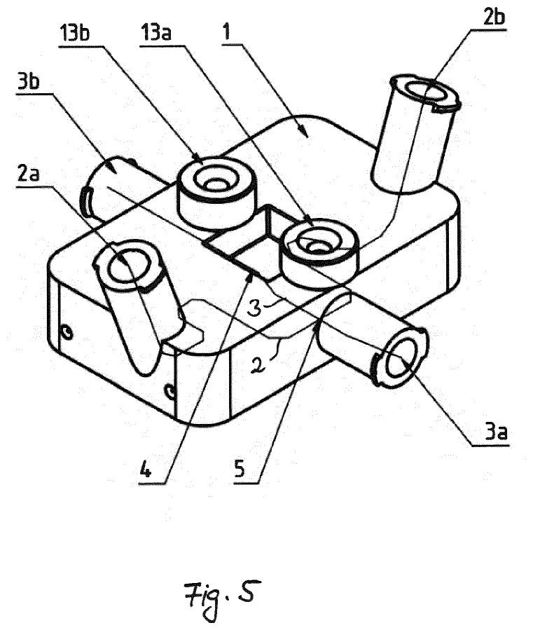

FIG. 5 shows another embodiment of a cartridge 1. Here, this cartridge forms a housing, in the interior of which channels 2 and 3 intersect one another, as is shown and described with respect to the other figures. The channels 2, 3 and the intersecting region 5 are only hinted at by dotted lines. As can be seen here, the respective ports 2a, 2b, 3a, 3b are designed as connectors for applicators to be attached, for example syringes, protruding from the cartridge housing, for example in the form of a Luer lock or in the form of another standardized connector.

A window of the reaction chamber 4 can be seen, through which the outcome of a reaction can be directly observed. A valve 13a is provided, so as to carry out the volume transfer of sample fluid between the channels 2 and 3, as described in FIG. 4.

This embodiment comprises a second valve 13b. This valve is disposed downstream from the reaction chamber 4 and, together with the valve 13a, is used to block the reaction chamber overall with respect to the channels. After reagent fluid has been added, the valves 13a and 13b can each be transferred into a position that blocks the reagent channel 3. The two valves can be mechanically coupled to one another so that one of the valves being moved also causes the other valve to be moved.

1. A cartridge for carrying out a reaction between a sample fluid and at least one reagent, the reaction comprising a LAMP assay, comprising at least one channel pair which includes a sample channel configured for introduction therein of a sample fluid and a reagent channel configured for introduction therein of a reagent fluid, the sample channel and the reagent channel being disposed so as to intersect one another to form an intersecting region configured so that a sample fluid can be transferred from the intersecting region into the reagent channel.

2. The cartridge according to claim 1, wherein the intersecting region of the two channels limits or defines a transfer volume of a sample fluid which can be transferred into the reagent channel.

3. The cartridge according to claim 2, wherein the transfer volume defined or limited by the intersecting region is a volume
a. that is present simultaneously in the sample channel and the reagent channel, which represents the intersection of the volumes of the two channels, multiplied by a factor U, the factor ranging between 0.75 and 1.25 or
b. that is of a through-channel formed in a valve element of a switching valve located in the intersecting region, the switching valve being configured to switch, alternatively, the sample channel or the reagent channel so as to be continuous at intersecting region.

4. The A cartridge according to claim 3, wherein each of the two channels extends between a respective inlet port and a respective outlet port in a meander-shaped manner at least in some regions, each of the two channels at each of the two ports thereof being openable and/or closable introducing fluid at the inlet port thereof and venting at the outlet port thereof.

5. The cartridge according to claim 4, wherein the inlet port of the sample channel, is connected to a sample receiving chamber configured to receive a sample carrier.

6. The A cartridge according to claim 5, wherein downstream from the intersecting region the reagent channel opens into a reaction chamber interposed in the reagent channel and having a cross-section that is greater than the cross-section of the reagent channel.

7. The cartridge according to claim 6, wherein a lyophilized reagent is stored in the reaction chamber or in a region of the reagent channel upstream from the reaction chamber.

8. The A cartridge according to claim 1, comprising a cartridge body made of a silicone, which is disposed on a carrier glass, the channels being surrounded by the cartridge body in some regions; and by the carrier element in some regions.

9. The cartridge according to claim 8, wherein all spatial regions of the cartridge body configured to be filled with fluid open into a planar connecting surface; via which the cartridge body is connected to a planar surface of the carrier element.

10. The cartridge according to claim 8, wherein the cartridge body and the carrier element are adhered to one another without interposed adhesive; and can be detached from one another without residue.

11. A cartridge body made of silicone and comprising channel-forming spatial regions configured to form channels configured to be filled with fluid; and which all open into a planar connecting surface; via which the cartridge body is configured to be connected to a planar surface of a carrier element glass to form a cartridge in which the channels are in surrounded by the cartridge body in some regions- and by the carrier element in some regions.

12. The cartridge according to claim 8, wherein the cartridge body is a product of a process comprising casting the silicone in a negative mold.

13. A carrier element comprising a glass plate configured for storage thereon of a lyophilized reagent and configured to be, joined with a cartridge body which is configured to form channels including a reagent channel configured for storage therein of the lyophilized reagent when the carrier element is joined with the cartridge body.

14. The cartridge according to claim 8, wherein the carrier glass comprises a microscope glass slide.

15. A method for carrying out a reaction between a sample liquid and at least one reagent, the reaction comprising a LAMP assay, comprising the following steps carried out with a cartridge according to claim 6:
a. filling the sample channel with a sample fluid beyond the intersecting region at which the sample channel is intersected by a reagent channel, the filling being carried out through the inlet port of the sample channel while the sample channel is being vented at the outlet port thereof and while the reagent channel is sealed with respect to a surrounding area, and
b. filling the reagent channel with a reagent fluid beyond the intersecting region at which the reagent channel is intersected by the sample channel, and into the reaction chamber, the sample fluid present in the intersecting region being transferred out of the intersecting region into the reaction chamber, the filling of the reagent channel being carried out through the inlet port of the reagent channel while the reagent channel is being vented at the outlet port of the reagent channel and while the sample channel is sealed with respect to the surrounding area.

16. The method according to claim 15, wherein, prior to the reagent channel being filled, the switching valve is switched from a through-position of the valve element for the sample channel into a through-position of the valve element for the reagent channel, whereby the sample fluid present in the valve element is transferred from the sample channel into the reagent channel.

17. The method according to claim 15, wherein when the sample channel is being filled with sample fluid, the reagent channel on both sides of the of the intersecting region is pinched of by compression of the cartridge body by a first pressing element and/or when the reagent channel is being filled with the reagent fluid, the sample channel on both sides of the intersection region is pinched off by compression of the cartridge body by a second pressing element.

18. The method according to claim 15, wherein that the cartridge and the sample fluid present therein are heated to a temperature greater than 90° C. for denaturing viral envelopes in the sample fluid, before filling the reagent channel led with the reagent fluid.
